(19) United States
(12) Patent Application Publication
(10) Pub. No.: US 2015/0009834 A1
(43) Pub. Date: Jan. 8, 2015

(54) GENERATION OF TIMING PULSES BASED ON ACQUIRED SYNCHRONIZATION

(71) Applicant: QUALCOMM Incorporated, San Diego, CA (US)

(72) Inventors: Umesh Srikantiah, San Diego, CA (US); Prashanth Haridas Hande, Somerset, NJ (US); Bhupinder Singh Parhar, Belle Mead, NJ (US); Raja Sekhar Bachu, Somerset, NJ (US)

(21) Appl. No.: 13/937,179

(22) Filed: Jul. 8, 2013

(51) Int. Cl. H04W 56/00

(52) U.S. Cl. CPC H04W 56/0015
USPC 370/242; 370/328

(57) ABSTRACT

A pulse-per-n-seconds signal may be generated at a wireless communication station to synchronize the internal hardware of the wireless communication station.

### BACKGROUND

I. Field

The present disclosure relates generally to communications, and more specifically to techniques for supporting operations in a wireless communication system.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

Such wireless communication networks may include relatively large cells, e.g., macrocells, and/or small cells. Small cells, such as microcells, picocells, and/or femtocells, may be deployed in wireless communication networks, e.g., to improve coverage. Synchronization of such small cells may be acquired from other cells in the network, e.g., by “network listening,” in which a base station of the small cell may detect signals broadcast from other cells, e.g., acquisition and/or pilot transmissions, and may acquire time and/or frequency synchronization based on the received signals. An issue, then, is how to synchronize the base station hardware (of the small cell), particularly with respect to timing.

### SUMMARY

Synchonization of the base station hardware may be performed, e.g., by generating a pulse-per-n-seconds signal (PPnS), where n is an integer greater than or equal to one. Such a PPnS may be generated, e.g., based on synchronization acquired by the base station from another base station, where such synchronization may be acquired based on various information and/or aspects of received signals.

Various aspects and features of the disclosure are described in further detail below.

### BRIEF DESCRIPTION OF THE DRAWINGS

FIG. 1 shows a conceptual block diagram of an apparatus that may be used in various aspects of this disclosure;

FIG. 2 shows a conceptual block diagram of a network showing how the apparatus of FIG. 1 may be incorporated according to various aspects of this disclosure; and

FIG. 3 shows a conceptual flowchart of operations according to various aspects of this disclosure.

### DETAILED DESCRIPTION

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies.

In the following description, for purposes of explanation and not limitation, details and descriptions are set forth in order to provide an understanding of the various aspects of this disclosure. However, it will be apparent to those skilled in the art that the various aspects may be practiced in other embodiments that depart from these details and descriptions.

Various aspects are described herein in connection with a base station. A base station may be utilized for communicating with one or more wireless terminals and can also be called, and may contain some or all of the functionality of, an access point, node, wireless node, Node B, evolved NodeB (eNode B or eNB) or some other network entity. A base station may communicate using an over-the-air interface with wireless terminals. The communication may take place through one or more sectors. The base station may act as a router between the wireless terminal and the rest of an access network, which may include an Internet Protocol (IP) network, e.g., by converting received frames to IP packets. The base station may also coordinate management of communication attributes and may also be the gateway between a wired network and the wireless network.

Various aspects or features will be presented in terms of systems that may include a number of devices, components, modules, or the like. It is to be understood and appreciated that the various systems may include additional devices, components, modules, and so on, and/or may not include all of the devices, components, modules and so on, discussed in connection with the figures. A combination of these approaches may also be used.

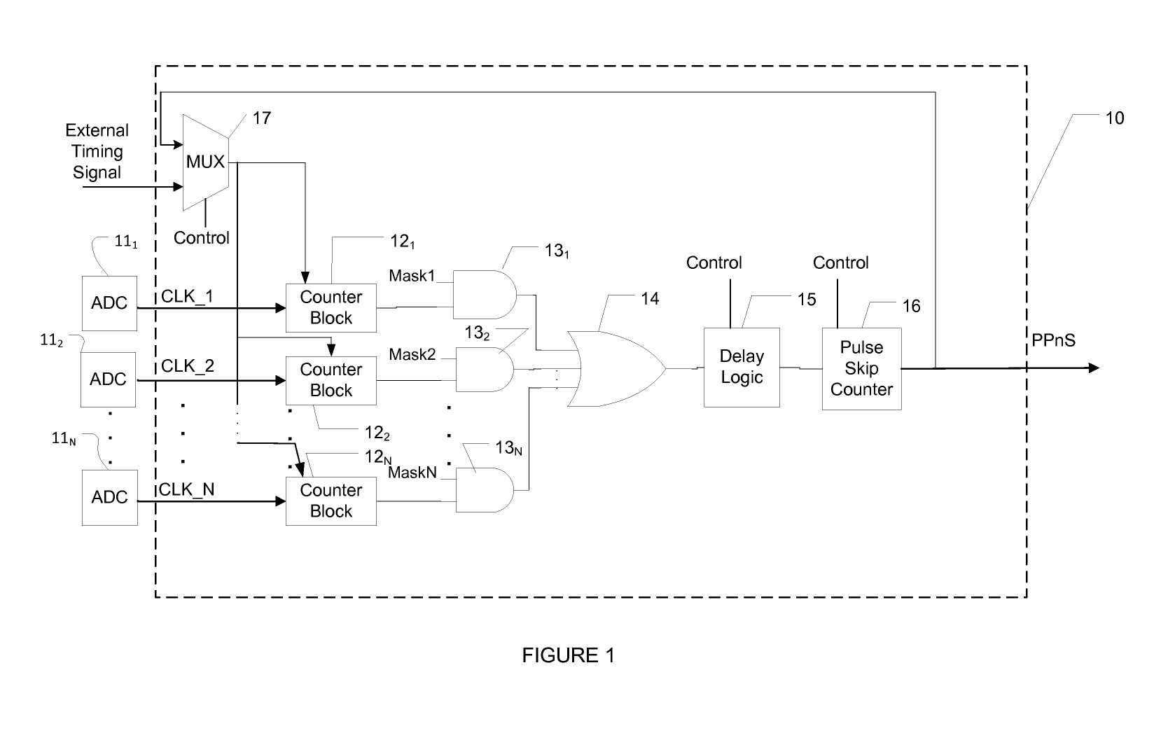

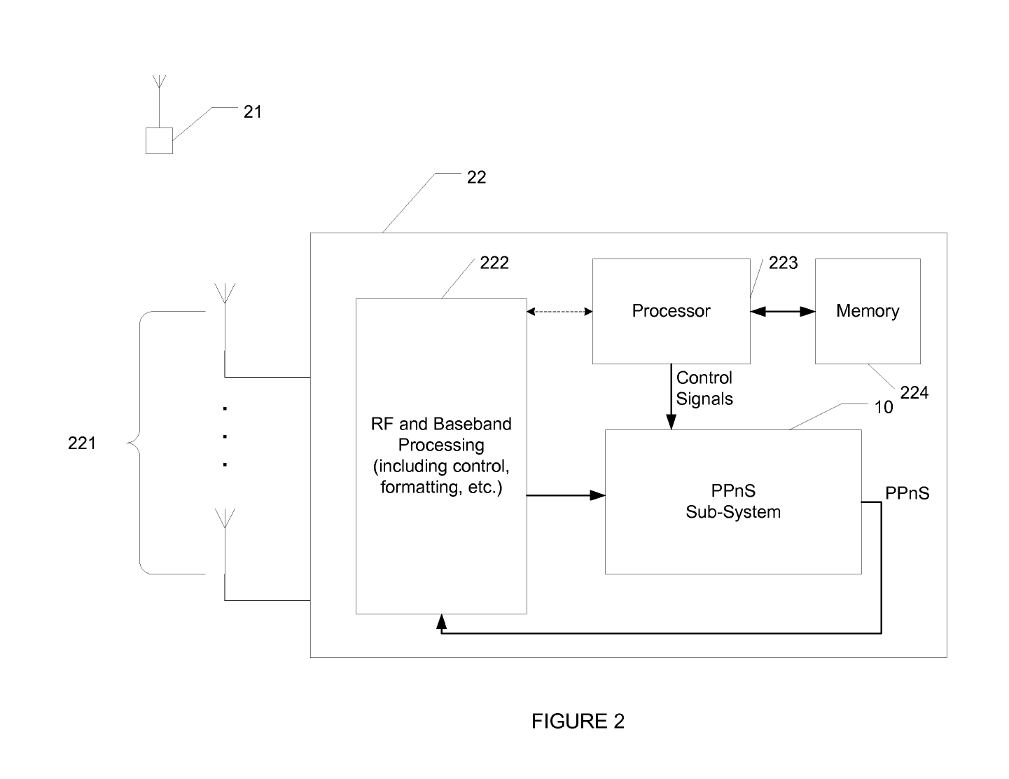

FIG. 1 shows a PPnS sub-system 10, and FIG. 2 shows an environment in which the PPnS sub-system 10 may be disposed, according to various aspects of this disclosure. As noted above, a base station 22 may perform network listening, in which base station 22 may acquire synchronization based on signals received from other base stations, e.g., base station 21. A PPnS sub-system 10 may be used in the base station 22 to generate a PPnS that may be used for timing purposes, e.g., within the base station 22.

As shown in FIG. 1, PPnS sub-system 10 may receive clock signals CLK_1, CLK_2, . . . ,CLK_N (where N is an integer) from analog-to-digital converters (ADCs) 11₁, 11₂, . . . ,11_{N}. ADCs 11₁, 11₂, . . . ,11_{N} may, for example, be located in the RF and baseband processing block 222, shown in FIG. 2. The clock signals CLK_1, CLK_2, . . . ,CLK N and ADCs 11₁, 11₂, . . . ,11_{N} may correspond to different communication technologies, such as LTE, UMTS, etc., to which the base station 22 may be tuned (i.e., base station 22 may, for example, include multiple antennas 221, as shown in FIG. 2 and discussed in further detail below, which, individually or in arrays, may be used to receive signals corresponding to different communication networks that may use different types of communication technologies; but the invention is not thus limited). The respective clocks of ADCs 11₁, 11₂, . . . ,11_{N} may be fed to clock inputs of respective counter blocks 12₁, 12₂, . . . ,12_{N}. The counter blocks 12₁, 12₂, . . . ,12_{N} may also receive a second input signal from multiplexer (MUX) 17. This signal may be used to synchronize the counter blocks 12₁, 12₂, . . . ,12_{N} and will be discussed further below.

Outputs of the respective counter blocks 12₁, 12₂, . . . ,12_{N} may be masked; such masking may be used to determine whether a particular unit is or is not used to generate the PPnS. This may be done, for example, using respective AND gates 13₁, 13₂, . . . , ¹3_{N}, which may have as inputs respective outputs of counter blocks 12₁, 12₂, . . . ,12_{N} and respective masking bits Mask1, Mask2, . . . , MaskN. This masking may be used, e.g., to provide flexibility to select a particular communication network and/or communication technology on which to base the PPnS. AND gates 13₁, 13₂, . . . , 13_{N} may thus provide means for selecting a count signal output by one or more of the counter blocks 12₁, 12₂, . . . ,12_{N}.

The outputs of the AND gates 13₁, 13₂, . . . , 13_{N} may then be fed into an OR gate 14. The output of the OR gate 14 may be fed into delay logic 15. An amount of delay introduced by delay logic 15 may be set by means of one or more control signal inputs and may be given in terms of a counter clock cycle of the particular counter block 12₁, 12₂, . . . ,12_{N}.

The output of the delay logic 15 may then be fed into a pulse skip counter 16. The pulse skip counter 16 may be controlled by one or more control signals. The pulse skip counter 16 may be used to determine pulse width and/or the value of n (i.e., to control how frequently pulses will be generated (i.e., a pulse frequency)); such PPnS parameters may, e.g., be expressed in terms of processor clock cycles corresponding to a processor that may be used to control baseband processing at the base station 22. The output of the pulse skip counter 16 may then be used as the PPnS.

The delay logic 15 and/or the pulse skip counter 16 may be considered to be means for adjusting at least one parameter of the signal received at the delay logic 15 to generate the PPnS.

As shown in FIG. 1, and as briefly noted above, the counter blocks ¹²₁, 12₂, . . . ,12_{N} may receive a synchronization signal from MUX 17. MUX 17 may receive as one input the PPnS, fed back from the pulse skip counter 16, and as a second input an external timing signal. The external timing signal may be, for example, a timing pulse from a navigation system, such as the Global Positioning System (GPS). The MUX 17 may be controlled by a control signal that selects either the PPnS or the external timing signal for feeding to the counter blocks 12₁, 12₂, . . . ,12_{N}. This may be used to provide flexibility to perform network listening or other network-based synchronization or to perform independent synchronization to a reference signal, such as a GPS timing pulse.

As noted above, the PPnS sub-system 10 may be incorporated into a base station 22, as shown in FIG. 2. Base station 22 may include one or more antennas 221. The base station 22 may also include a radio-frequency (RF) and baseband processing block 222. The RF and baseband processing block may include components necessary to process analog and/or digital signals in order to transmit and receive signals, to format data for transmission and de-format data for reception, control functionality (e.g., in order to implement communication protocols), and other functions that may be involved in transmitting and receiving information. The RF and baseband processing block 222 may provide means for acquiring timing from a received signal. Base station 22 may include at least one processor 223 and at least one memory 224; these components may be incorporated into RF and baseband processing block 222 or may be external to RF and baseband processing block 222, or both.

As previously noted, the ADCs 11₁, 11₂, . . . ,11_{N} shown in FIG. 1 may, for example, be located in the RF and baseband processing block 222. The RF and baseband processing block 222 may thus be coupled to PPnS sub-system 10 to provide at least the clock output signals of the ADCs 11₁, 11₂, . . . ,11_{N} to PPnS sub-system 10; RF and baseband processing block 222 may also provide other inputs to PPnS sub-system 10. In turn, the RF and baseband processing block 222 may receive the PPnS output signal from PPnS sub-system 10; it is noted that the RF and baseband processing block 222 may also receive other signals from PPnS sub-system 10.

The at least one processor 223 may provide control signals to PPnS sub-system 10. These control signals may be used to control delay logic 15 and/or to control pulse skip counter 16, as has been described above. The at least one processor 223 may also provide the control signal to MUX 17 to select either the PPnS or the external timing signal for providing to the counter blocks 12₁, 12₂, . . . ,12_{N}. The counter blocks 12₁, 12₂, . . . ,12_{N} may thus provide means for generating count signals based on acquired timing. Additionally, the at least one processor 223 may provide the masking bits Mask1, Mask2, . . . , MaskN.

The at least one processor 223 may also be coupled to RF and baseband processing block 222 and may provide associated control functionality. Furthermore, at least one memory 224 may be provided. The at least one memory may be used to store instructions that, if executed by the at least one processor 223, may result in the implementation of various operations that may, e.g., provide the control signals discussed above. The at least one memory 224 may also store information, parameters, or other data. The at least one processor 223 may also be coupled to a user interface or communication interface (not shown) to obtain parameters (e.g., control parameters, which may include pulse width/duration, the value of n, and/or delay) and/or other information from a user or from another source.

The at least one processor 223 may also be programmed to determine various parameters and/or the masking bits based on measurements and/or programmed parameters or preferences. Measurements may include monitoring internal systems of the base station 22 or external signals. The program(s) for the at least one processor 223 may be stored, e.g., in at least one memory 224.

While not specifically shown, control functionalities may be implemented, in whole or in part, in the form of firmware or hardware. This aspect of the disclosure is not limited to software implementations.

As noted above, the base station 22 may receive a signal, e.g., from another base station 21, based on which it may acquire synchronization. The signal from another base station 21 may, for example, be a beacon or reference signal, or it may be a data signal. The received signal may incorporate an absolute time indication that may be obtained by the base station 22. Alternatively, base station 22 may acquire timing from the received signal by detecting the timing of a repeated feature or pattern found in the received signal or by detecting the timing of a pattern within the received signal (e.g., occurrence of the beginning of a frame or sub-frame, occurrence of a known preamble sequence, occurrence of a particular flag or bit sequence, boundaries between particular fields within the signal, or the like).

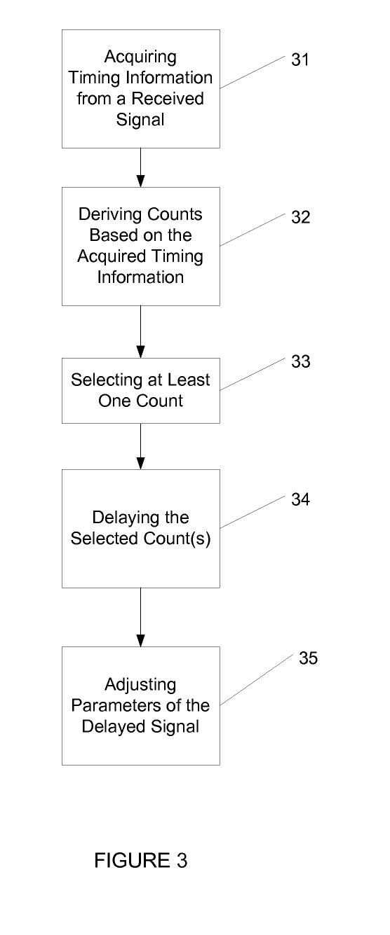

FIG. 3 depicts a conceptual flowchart of operations that may be used in various aspects of this disclosure and/or in conjunction with the above-described components. Timing information may be obtained from a received signal 31, where the signal may be, e.g., from another base station. Counts may be computed based on the acquired timing information 32. One or more of the counts may be selected 33 for use in generating a PPnS. The one or more selected count signals may be subjected to delay 34, and/or other parameters, e.g., but not limited to pulse width, may be adjusted 35. The result may be output as the PPnS.

The PPnS may be used in multiple ways. One way is to generate clock signals for timing various components of the RF and baseband processing block 22, for example. The PPnS may also be used to generate time and/or frequency error reports that may be used, e.g., in controlling at least one oscillator.

For example, the PPnS may be used to control a main oscillator of a chip or chip set, which may, in turn, be used to derive other oscillator signals. An error report may be generated, for example, by using a counter (not shown) to count a number of clock cycles of an oscillator (e.g., the main oscillator) that occur between two successive PPnS pulses. The number of clock cycles thus obtained may be compared with an expected number of clock cycles to determine whether the oscillator requires adjustment.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal

In one or more exemplary designs, the functions described may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
acquiring, at a wireless base station, timing from a received signal;
using the acquired timing to generate one or more count signals;
selecting at least one signal of the one or more count signals; and
adjusting at least one parameter of the at least one signal to generate a pulse-per-n-seconds signal, where n is an integer greater than or equal to one.

2. The method of claim 1, wherein the acquiring comprises deriving timing from an absolute time reference contained in the received signal.

3. The method of claim 1, wherein the acquiring comprises deriving timing from a feature of the received signal.

4. The method of claim 3, wherein the feature of the received signal comprises a repeated feature or multiple features.

5. The method of claim 1, wherein the received signal is a received via a wireless channel.

6. The method of claim 1, further comprising:
generating a time error report, frequency error report, or both, based on the pulse-per-n-seconds signal; and
using the time error report, frequency error report, or both to control at least one oscillator.

7. The method of claim 1, wherein the adjusting at least one parameter comprises performing said adjusting using a programmable system.

8. The method of claim 1, wherein the adjusting includes adjusting one or more parameters selected from the group consisting of: a delay of the at least one signal, a pulse duration of the at least one signal, and a value of n of the pulse-per-n-seconds signal.

9. The method of claim 1, further comprising selecting one of the pulse-per-n-seconds signal to synchronize the one or more count signals or an external timing signal to use in synchronizing the one or more count signals.

10. An apparatus for wireless communication, comprising:
means for acquiring timing from a received signal;
means for using the acquired timing to generate one or more count signals;
means for selecting at least one signal of the one or more count signals; and
means for adjusting at least one parameter of the at least one signal to generate a pulse-per-n-seconds signal, where n is an integer greater than or equal to one.

11. A wireless communication apparatus, comprising:
a corresponding plurality of counter blocks coupled to receive as inputs respective clock signals from a signal processing block configured to acquire timing based on a received signal;
a selection device configured to receive outputs of the plurality of counter blocks and to select one or more of the outputs of the plurality of counter blocks to generate a pulse signal; and
a parameter adjusting device configured to adjust one or more parameters of the pulse signal to obtain an output pulse signal.

12. The wireless communication apparatus of claim 11, wherein the selection device comprises a plurality of AND gates coupled to receive the respective outputs of the plurality of counter blocks and to also receive as inputs masking bits to select or not select one or more of the outputs of plurality of counter blocks to provide to the parameter adjusting device.

13. The wireless communication apparatus of claim 11, wherein the parameter adjusting device comprises a programmable delay device.

14. The wireless communication apparatus of claim 11, wherein the parameter adjusting device is programmable, and wherein the parameter adjusting device is configured to adjust one or more pulse signal parameters selected from the group consisting of: pulse width and pulse frequency.

15. The wireless communication apparatus of claim 11, further comprising a feedback loop configured to selectably feed the output pulse signal to the plurality of counter blocks.

16. The wireless communication apparatus of claim 15, wherein the apparatus is configured to feed an external timing signal to the plurality of counter blocks when the output pulse signal is not fed to the plurality of counter blocks.

17. The wireless communication apparatus of claim 11, further comprising a plurality of analog-to-digital converters having corresponding clock signals, wherein the corresponding clock signals are coupled to inputs of the plurality of counter blocks.

18. The wireless communication apparatus of claim 11, further comprising a signal processing block configured to acquire timing from the received signal.

19. The wireless communication apparatus of claim 18, wherein the received signal is received via a wireless communication channel.

20. The wireless communication apparatus of claim 11, wherein the timing is acquired based on a characteristic of the received signal selected from the group consisting of: an absolute timing reference in the received signal; a repeated feature or pattern in the received signal; and a feature or pattern within the received signal.
